(19) United States
(12) Patent Application Publication
(10) Pub. No.: US 2004/0044782 A1
(43) Pub. Date: Mar. 4, 2004

(54) Transmission of service control information via at least one intermediate station

(76) Inventor: Helmut Schmidt, Munich (DE)

Correspondence Address: MORRISON & FOERSTER LLP, 1650 TYSONS BOULEVARD, SUITE 300, MCLEAN, VA, 22102, US

(21) Appl. No.: 10/221,375

(22) PCT Filed: May 10, 2001
(86) PCT No.: PCT/DE01/01534

(30) Foreign Application Priority Data
May 29, 2000 (DE) 100 26 653.3

(51) Int. Cl. G06F 15/16

(52) U.S. Cl. 709/230; 709/236; 709/238

(57) ABSTRACT

A method and system are provided by which all supplementary services are made available when telephoning over the Internet using an appropriate data terminal. An intermediate station (e.g., gateway) is provided with a services distributor that serves as a unit for differentiating services control data to be carried out locally and services control data to be passed farther along the signaling segment. The services distributor makes use of a code by which each service is assigned to a specific station.

The present invention relates to a method as well as to a system for transmission of services control data by way of at least one signaling segment containing at least one intermediate station.

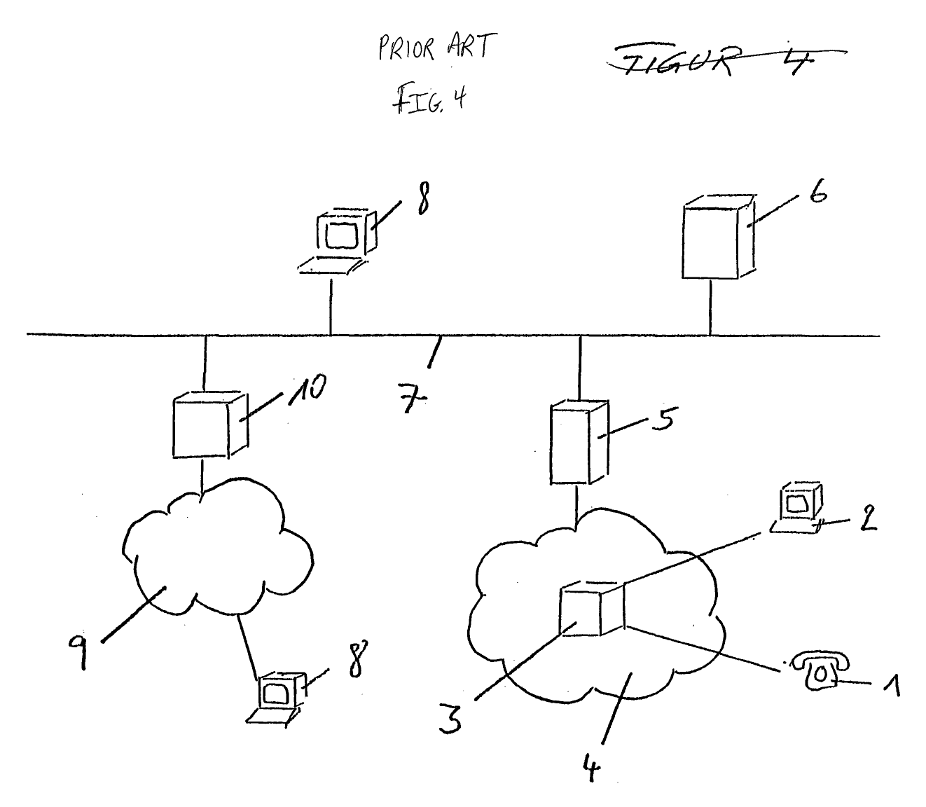

In the state of the art (see FIG. 4), it is possible to communicate with another data terminal 8 (H.323 terminal), by way of the Internet, using an analog telephone 1 or an ISDN telephone 2. For this purpose, an exchange-side switching center 3 (e.g., EWSD) of the public telephone network 4 is connected with a local network 7 (Ethernet) by way of an H.323 gateway 5.

In this connection, H.323 is an international standard for voice, data, and video communication by way of packet-oriented networks. It establishes the specific capabilities of terminals in the IP (Internet protocol) environment.

A gateway 5 is understood to mean the hardware and software that is required in order to connect different networks (here, the public telephone network 4 and the Ethernet 7, i.e., the connection-oriented ISDN network and the packet-oriented Ethernet, for example) with one another. A gateway 5 has the task of transmitting messages from one computer network into another computer network, for which purpose it is primarily necessary to translate the communications protocols. It can be viewed as a type of protocol converter that understands the protocols on both sides and represents an addressable network node in both networks.

The local network 7 (Ethernet) is connected with the H.323 terminal by means of a router 10, by way of the Internet 9. Routers 10 connect sub-networks on the switching layer of the OSI reference model.

The central control element for routing the call signaling, but also for resolving the telephone numbers as well as the IP address, i.e., converting them, is the H.323 subscriber switching center 6 (gatekeeper) that is also connected to the local network 7 (Ethernet). The gatekeeper 6 is responsible for access entitlement and security. Furthermore, the gatekeeper 6 records the charges and assigns them to the partners in the networks.

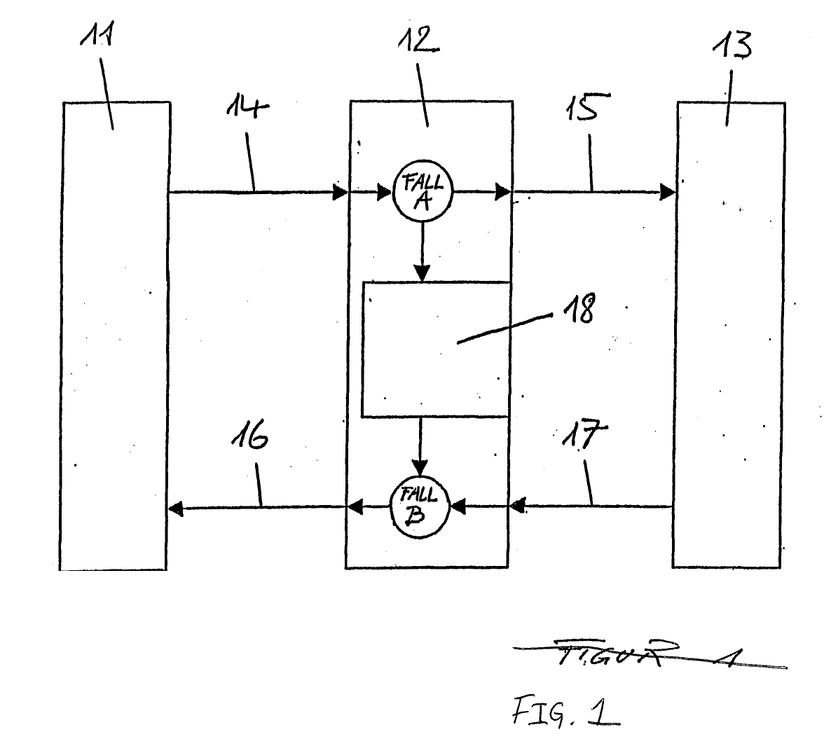

In every case, the above arrangement (FIG. 1) makes it possible to telephone by means of an H.323 terminal 8, in other words by means of an ISDN data terminal for data input and data output, which generally consists of a keyboard, a screen, and a processor, by way of the local network 7 as well as by way of the Internet 9.

However, when different networks are linked by such a gateway, there is the great disadvantage that in connection with use for telephony by way of the Internet, a number of additional services familiar from ISDN technology (Supplementary Services), such as call forwarding, display of charges, call waiting, etc., are not possible.

This is because the DSS1 protocol developed for control of ISDN terminals only has local significance, i.e., it is only designed for communication between two adjacent stations. According to the state of the art, the switching center (e.g., EWSD) 3 in the public telephone network 4, as the first end point, therefore cannot transmit control data for supplementary services to a data terminal 8 as the second end point, by way of the gateway 5 as an intermediate station.

One possibility for circumventing this problem is to use a protocol QSIG derived from the DSS1 protocol, which can span several stations by means of the introduction of a special data element (the so-called NFE “Network Facility Extension”). However, this is connected with a change in the exchange-side switching center and therefore with a significant expenditure of costs.

It is therefore the task of the present invention to inexpensively make all supplementary services available, as they correspond to a normal telephone connection, also when telephoning over the Internet, using an appropriate data terminal (e.g., PC).

This task is accomplished, according to the present invention, in that the intermediate station (e.g., gateway) has a services distributor that serves as a unit for differentiating services control data to be carried out locally and services control data to be passed farther along the signaling segment.

In the differentiation, the services distributor makes use of a code, by means of which each service is assigned to a specific station.

After the services control data have been processed, a confirmation can be sent to the source of the services request (as a function of the service, in each instance), which confirmation contains information that guarantees that the confirmation is distributed to the correct location.

The intermediate station has a protocol entity to which the services distributor is coupled, and which transfers all the received services control data and any additional further information on to the services distributor.

Furthermore, according to the invention, a method for transmitting services data from a first end point by way of at least one intermediate station, spanning a signaling segment to a second end point, is claimed, this method comprising the following steps:

Sending the services control data from an end point to at least one intermediate station, as well as differentiating between local services control data, in other words data to be carried out in the intermediate station, and services control data to be passed farther along the signaling segment.

In addition, a method and a system for transmitting services control data are claimed, this transmission taking place from a first end point of a signaling segment, by way of a first network, to a gateway, and from the gateway, by way of a second network that is different from the first network, to the second end point of the signaling segment.

In this connection, the gateway packs the services control data received from the first end point into a data container that is adapted for transmission by way of the second network and carries out this transmission.

Other advantages, characteristics, and features of the present invention will now be explained in greater detail, on the basis of exemplary embodiments, making reference to the accompanying drawings.

FIG. 1 shows a configuration according to the invention, in which the DSS1 protocol, contrary to its original purpose of use, is used on a signaling segment that spans several stations,

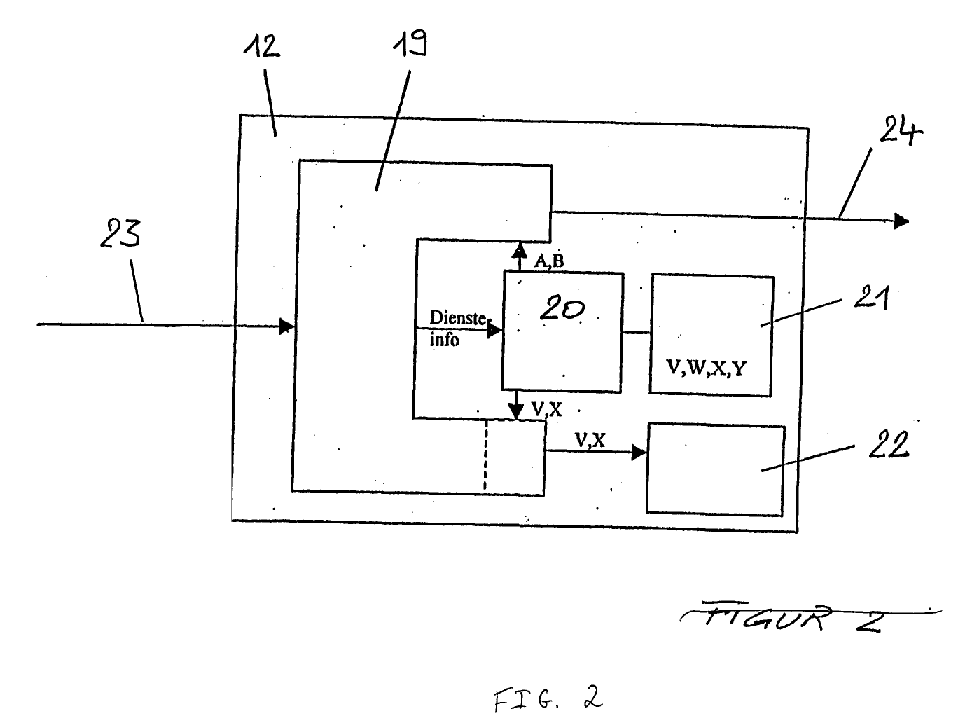

FIG. 2 shows the position and the function of the services distributor as well as the protocol unit in an intermediate station,

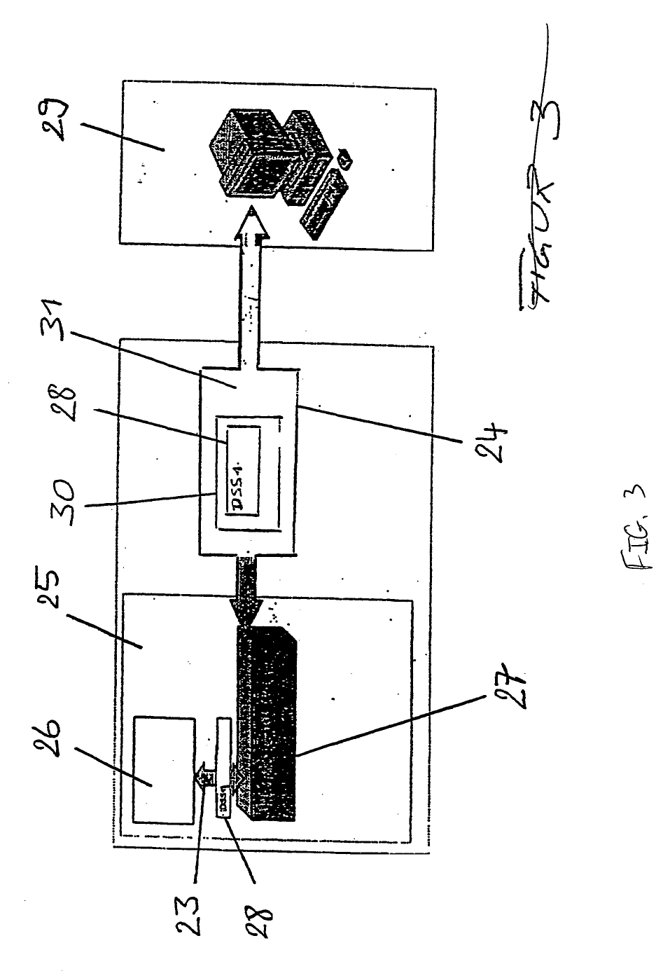

FIG. 3 shows an exemplary configuration,

FIG. 4 shows the H.323 structure model according to the state of the art.

FIG. 1 shows a configuration according to the invention, in which the DSS1 protocol, contrary to its original purpose of use, is used on a signaling segment that spans several stations. There is at least one intermediate station 12 (which does not necessarily have to be physically separate from the end points) between the first end point 11 and the second end point 13. The first end point 11 can be a switching center (EWSD), for example, and the second end point 13 can be another terminal (PC with telephony application according to Internet protocol).

Now the invention will be explained in detail: One possible method for controlling services data is the so-called Generic Functional Protocol integrated into the DSS1 protocol. The corresponding services control data are transmitted in so-called ROSE components (Remote Operation Service Element) within a special parameter (the Facility Information Element).

In this connection, there are four ROSE components: a request component (Invoke component), as well as three confirmation components (Return Result, Return Error, and Return Reject component). While the confirmation components only contain an identifier (Invoke ID) that makes the services request clear within the signaling connection, the invoke component additionally contains an operation code, by means of which each supplementary service receives a clear assignment.

The configuration shown in FIG. 1 is now supposed to behave in such a way, according to the invention, that services control data 14 transmitted from the first end point 11 are evaluated either by the second end point 13 or by local services programs 18 of the intermediate station 12. Therefore, in case A, the services control data 14 must be distributed from the first end point 11 to the intermediate station 12 and, by means of a DSS1 message 15 that has been passed on, to the second end point 13. In case B, the services control data 17 proceed from the second end point 13 and must be linked up with services control data from local services programs in the intermediate station 12, and passed to the first end point 11 as an expanded DSS1 message 16.

This scenario as just described presumes that the intermediate station 12 has the possibility of differentiating between services control data to be processed locally or in a remote manner, on the basis of their content, and of sending these data to the local processing unit 18 or the respective end point 11 or 13 as a function of this differentiation.

Such a method will now be described using FIG. 2. A unit for differentiating between services control data to be carried out locally and to be passed farther along the signaling segment 23, 24 is integrated into the intermediate station 12. This unit is referred to as a services distributor 20 in the following.

The nomenclature used in the following is derived from the ROSE protocol, but can fundamentally also be applied to other methods for services control. Likewise, the services control data can also be transported by way of other transport mechanisms, other than the DSS1 Generic Functional Protocol.

In this connection, the configuration of the intermediate station 12 meets the following requirements:

In order to be able to configure the services distributor 20 clearly, all of the stations along the signaling segment 23, 24 that process the services control data must be configured in such a way that a specific service (identified by its operation code) is only carried out by a specific station.

In order to assure a clear distribution of the confirmations (which contain only the identifier (Invoke ID), as mentioned above) or, to put it differently, in order to be able to clearly assign a confirmation to a services request when the confirmation is received, the end points that send the services control data, or the intermediate stations, are configured in such a way that they use only identifiers (Invoke IDs) within a specific range. The identifier is sent by the party that sends the services request.

Within each intermediate station 12, the operation codes of the services to be carried out locally, i.e., in the intermediate station 12, and the range of the locally generated identifiers are stored in memory. Information about services not to be carried out locally does not have to be stored in memory in the intermediate station 12.

As shown in FIG. 3, the services distributor 20 is coupled with a protocol control unit 19 of the intermediate station 12. The protocol control unit 19 transfers all of the received services control data and any additional information, such as the direction and the transport mechanism in which the services control data were transported, to the services distributor 20. The services distributor 20 determines, per services control data item, whether it is supposed to be passed farther along the signaling segment or whether the service is to be performed locally.

For example, the signaling message 23 contains the services control data that the services A and B are to be carried out by the second end point (not shown in FIG. 3), while the services V and X are to be carried out locally. The services distributor 20 recognizes this by the fact that the operation code of V and X is contained in a local services list 21. The services control data to be processed locally can either be passed on by the services distributor 20 directly to the unit 22 that carries them out, or (provided with a special marking or in a special data region) can be given back to the protocol control unit 19.

The services control data A and B, which must be passed farther along the signaling segment, are given back to the protocol control unit 19 and passed on by the latter in the form of a signaling message 24.

If the services distributor 20 receives confirmations on the basis of services requests sent earlier, it determines whether or not the identifier contained in the confirmation was issued locally.

The services distributor is generally not needed for bringing together locally generated and received services information (i.e., guarantee of functionality in the opposite direction). Since no knowledge about the services is required in this case, it can be handled by the protocol control unit 19 on its own. However, it must be assured that the identifiers of the services control requests are in the range established previously, in order to allow a subsequent clear distribution of resulting confirmations.

If existing terminals that cannot be configured are used, it is generally not possible to restrict the ranges for the identifiers. In this case, the services distributor 20 must also be used for bringing together locally generated and received services data. In this connection, the identifiers of all services requests must be stored in memory together with their source (“local” or “remote”). If the same identifier already exists, because it was already assigned by another location, it must be changed to a value that has not been used yet, when the data are brought together, in order to assure that the identifiers are clear on the signaling segment 23, 24. If the identifier was changed when the data were brought together, it must be reset to the original value during distribution. Confirmations received from the opposite direction must be sent using both information items, the identifier contained and the source of the services request.

In general, the method can be used in both directions of a signaling segment. However, if services control data are brought together only in one direction (as in FIG. 3, for example), the division of identifiers into non-overlapping ranges only has to take place in the one direction, and the distribution only has to take place in the opposite direction.

FIG. 3 shows an exemplary embodiment of the invention. All of the DSS1 supplementary services are supposed to be available to an H.323 client 29 (PC with IP telephony application). For this purpose, the switching system 25 (EWSD) must be expanded accordingly, with a new unit. The new unit, an H.323 gateway PCU (Peripheral Control Unit) 27, corresponds to the intermediate station in the sense of the invention, while the EWSD core 26 and the H.323 client 29 are the end points. The transmission protocol being used is the DSS1 protocol.

The H.323 client 29 is therefore supposed to be able to understand the typical DSS1 services control data. For this purpose, the EWSD core 26 is configured for a DSS1 terminal (ISDN telephone). The H.323 gateway PC 27 packs the DSS1 message 28 received from the EWSD core 26 (with the exception of the services control data intended for the H.323 gateway PCU 27 itself) into a data container 30 that is suitable for transmission by way of an H.323 network.

This data container 30 is transmitted to the H.323 client 29 in a suitable H.225 message 31 (H.225 Call Control Message).

The fact that the DDS1 protocol, which was actually developed for local signaling, is transported over several stations in this arrangement (from the EWSD core 26 directly to the H.323 gateway PCU 27 and from there in the container to the terminal of the H.323 client 29) is clearly evident.

However, a DSS1 message transmitted form the EWSD core 26 to the H.323 gateway PCU 27 can also contain services control data that serve for control of the H.323 gateway PCU 27 and therefore are not supposed to be transported to the H.323 client 29. In order to assure this, a services distributor has to be integrated into the H.323 gateway PCU 27. This works according to the method according to the invention, in that it recognizes what services control data are intended for the H.323 gateway PCU 27 and what data must be passed on to the H.323 client 29, within the container.

1. Method for transmission of services control data from a first end point (11) by way of at least one intermediate station (12) spanning a signaling segment (23, 24), to a second end point (13), having the following steps:
sending the services control data from an end point (11) to at least one intermediate station (12),
differentiating between local services control data, in other words data to be carried out in the intermediate station (12), and services control data to be passed farther along the signaling segment (23, 24),
carrying out the local services control data in the intermediate station (12) and passing on the other services control data to the second end point (13) or to another intermediate station.

2. The method as recited in claim 1, characterized in that
the step of differentiation is based on decoding a code by means of which each service is clearly assigned to a specific station.

3. The method as recited in claim 1 or 2, characterized in that after the services control data have been carried out, the source of the services request is sent a confirmation that contains an identifier that assures clear distribution of the confirmation.

4. System for transmission of services control data from a first end point (11), by way of at least one intermediate station (12) spanning a signaling segment (23, 24), to a second end point (13), characterized in that the intermediate station (12) has a services distributor (20) that is configured as a unit for differentiating services control data to be carried out locally and services control data to be passed farther along the signaling segment (23, 24).

5. The system as recited in claim 4, characterized in that the services distributor is configured in such a way that it uses a code for the differentiation, by means of which code each service is clearly assigned to a specific station.

6. The system as recited in claim 4 or 5, characterized in that the intermediate station (12) has a protocol control unit (19) to which the services distributor (20) is coupled, and which transfers all of the received services control data and any additional data to the services distributor.

7. Method for transmission of services control data from a first end point (26) of a signaling segment (23) by way of a first network, to a gateway (27), and from the gateway (27) by way of a second network, different from the first network, to a second end point (29) of the signaling segment (24), characterized in that the gateway (27) packs the services control data received from the first end point (26) into a data container (30), which is adapted for transmission by way of the second network, and carries out this transmission.

8. The method as recited in claim 7, characterized in that packing the services control data into a data container (30) serves to transport the corresponding DSS1 message (28) by way of several intermediate stations of different networks (25) (29).

9. The method as recited in one of claims 7 and 8, characterized in that the first end point represents an EWSD switching center (25), the first network is the local network of this switching center (25), the second network is the public ISDN network, and that the second end point represents an H.323 client (29).

10. System for transmission of services control data from a first end point (26) of a signaling segment (23) by way of a first network, to a gateway (27), and from the gateway (27) by way of a second network, different from the first network, to a second end point (29) of the signaling segment (24), characterized in that the gateway (27) is configured in such a way that it packs the services control data received from the first end point (26) into a data container (30), which is adapted for transmission by way of the second network, and carries out this transmission.

11. The system as recited in claim 10, characterized in that the first end point represents an EWSD switching center (25), the first network is the local network of this switching center (25), the second network is the public ISDN network, and that the second end point represents an H.323 client (29).

12. The system as recited in claim 10 or 11, characterized in that packing the services control data into a data container (30) serves to transport the corresponding DSS1 message (28) by way of several intermediate stations of different networks.
